(19) United States
(12) Patent Application Publication
(10) Pub. No.: US 2025/0132835 A1
(43) Pub. Date: Apr. 24, 2025

(54) SYSTEMS AND METHODS FOR RECONFIGURABLE COHERENT PON

(71) Applicant: CABLE TELEVISION LABORATORIES, INC., Louisville, CO (US)

(72) Inventors: ZHENSHENG JIA, Superior, CO (US); HAIPENG ZHANG, Broomfield, CO (US); CURTIS D. KNITTLE, Broomfield, CO (US)

(21) Appl. No.: 18/925,317

(22) Filed: Oct. 24, 2024

Related U.S. Application Data
(60) Provisional application No. 63/545,436, filed on Oct. 24, 2023.

(51) Int. Cl. H04B 10/27; H04B 10/40

(52) U.S. Cl. CPC H04B 10/27; H04B 10/40

(57) ABSTRACT

A first coherent transceiver for a CPON includes a MAC layer for enabling dual-mode operation of the first coherent transceiver, a software management and control module for communicating with a second transceiver over an ODN communication channel, a coherent DSP in communication with the software management and control module and configured to process a digital signal from the MAC layer, and an optics infrastructure configured to transmit and receive analog data signals over the ODN to and from the second transceiver, respectively. The analog data signals include a communication subcarrier and a data subcarrier. The digital data signal includes a first data portion with control information from the communication subcarrier, and a second data portion with primary information from the data subcarrier. The coherent DSP further dynamically reconfigures digital data signal processing between first and second operational modes based on a transport type of the data channel subcarrier.

### CROSS REFERENCE TO RELATED APPLICATIONS

This application claims the benefit of and priority to U.S. Provisional Patent Application Ser. No. 63/545,436, filed Oct. 24, 2023, which is incorporated herein by reference in its entirety.

### BACKGROUND

The field of the disclosure relates generally to communication networks, and more particularly, to reconfigurable coherent optical networks.

Conventional passive optical networks (PONs) are known to use point-to-multipoint (P2MP) architectures that are implemented extensively worldwide, and which have become a primary vehicle to meet the growing capacity demands in optical access networks. PON technology and architectures are expected to grow significantly in the near future, due to such factors as (a) increasing demand for high-speed internet, (b) need for more efficient and reliable network infrastructures, and (c) increasing adoption of fiber-to-the-home (FTTH) and fiber-to-the-premises (FTTP) technologies that rely on PONs to deliver high-speed internet access to homes and businesses. Additionally, driven by the desire for minimal latency, decreased jitter, and enhanced quality of experience (QoE) in virtual reality (VR) games and cloud-based applications, there is a desire in the optical communication field to continue to grow and improve fiber access technologies.

Conventional standardized PONs, however, primarily utilize intensity modulation direct detection (IM-DD) technology, with non-return-to-zero (NRZ) format. Standardization of conventional PON generations has focused on increasing the data rate, raising the launched power, and/or improving forward error correction (FEC) to fulfill a 29-dB or higher loss budget, which is a requirement for coexistence with legacy PONs and/or reuse of a deployed optical distribution network (ODN). IM-DD technology, however, has been unable to meet the needs for the emerging 100G PON standard, due to such known IM-DD limitations such as insufficient power budgets, bandwidth limitations, and transmission impairments such as chromatic dispersion (CD).

Moreover, conventional IM-DD transceivers, such as the optical line terminal (OLT) and the optical network unit (ONU), are neither advanced nor complex enough, in comparison with previous generational PONs, to reach 100 Gbps. To stay within the required power budget for an IM-DD 100G PON, a significantly high launch power would be required, e.g., from 8 dBm to 11 dBm, of the respective optical amplifiers of the conventional IM-DD OLT and its respective ONUs. However, conventional IM-DD ONUs are unable to achieve such high launch powers in the upstream, and are further known to experience significant penalties for high-baud-rate signals due to fiber dispersion. Additionally, coexistence with legacy PON has been challenged to find a suitable transmission wavelength window in the O-band. Accordingly, the industry has recognized that it is too challenging for a conventional 100G TDM-PON using direct detection in the O-band to meet the required power budget for a single wavelength. This challenge becomes even more pronounced with respect to the extended power budgets for long-reach and/or high-density applications.

Recent solutions based on coherent PON (CPON) technology though, have offered solutions to meeting these new high speed demands, due to the heightened sensitivity, advanced modulation, and robust digital signal processing (DSP) exhibited by CPON, in comparison to IM-DD PONs. Coherent optics, for example, avoids many of the challenges experienced using IM-DD technology by dividing the data speed into four separate lanes of two polarizations each. By modulating both amplitude and phase, coherent optics technology enables operation at one fourth of the line rate required by IM-DD technology. Coherent optics thus enables optical transmission systems and dense wavelength division multiplexing (DWDM) networks having speeds of 100 Gbps, 200 Gbps, and 400 Gbps per wavelength.

Whereas IM-DD technology only considers amplitude to represent the detected signal (i.e., one-dimensional), coherent optical solutions use a high-power local laser source as a reference to achieve linear conversion of the optical field, as opposed to the optical power used in direct detection, thereby enabling multi-dimensional modulation and detection of a signal using four independent degrees of freedom, including amplitude and phase, and for two polarizations each. Additionally, the CPON is similar, in general topology, to the conventional IM-DD PON, and particularly with respect to P2MP topologies over a passive ODN. The CPON differs though, from the conventional IM-DD PON, in that the CPON uses multi-dimension modulation and coherent detection to provide longer reach and higher split ratio with improved optical power budget. There is a desire in the industry, however, to more easily reconfigure an existing CPON for the differing scenarios and requirements of single-carrier (SC) transport in each direction over a fiber (i.e., OLT-ONU, ONU-OLT), as opposed to multiple digital subcarriers (DSCs) transported over the same fiber.

### BRIEF SUMMARY

In an embodiment, a first coherent transceiver for a coherent passive optical network (CPON) includes a media access control (MAC) layer configured to enable dual-mode operation of the first coherent transceiver, a software management and control module configured to communicate with a remote second transceiver over a first communication channel of an optical distribution network (ODN), a coherent digital signal processor (DSP) in communication with the software management and control module and configured to process a digital data signal from the MAC layer, and a coherent optics infrastructure configured to transmit and receive analog data signals over the ODN to and from the remote second transceiver, respectively. The analog data signals include a communication channel subcarrier and a data channel subcarrier. The digital data signal from the MAC layer includes a first data portion with control information from the communication channel subcarrier, and a second data portion with primary information from the data channel subcarrier. The coherent DSP is further configured to dynamically reconfigure processing of the digital data signal between a first operational mode and a second operational mode based on a transport type of the data channel subcarrier.

In an embodiment, a digital signal processor (DSP) for a coherent transceiver includes a processor input configured to receive an input digital data signal, an operational mode selection unit configured to select between a single-channel (SC) operational mode of the coherent transceiver and a multiple-channel (DSC) operational mode of the coherent transceiver, an SC processing path for processing the input digital data signal in the SC operational mode, a DSC processing path for processing the input digital data signal in the DSC operational mode, and a processor output configured to output results from the SC and the DSC processing paths.

### BRIEF DESCRIPTION

These and other features, aspects, and advantages of the present disclosure will become better understood when the following detailed description is read with reference to the accompanying drawings in which like characters represent like parts throughout the drawings, wherein:

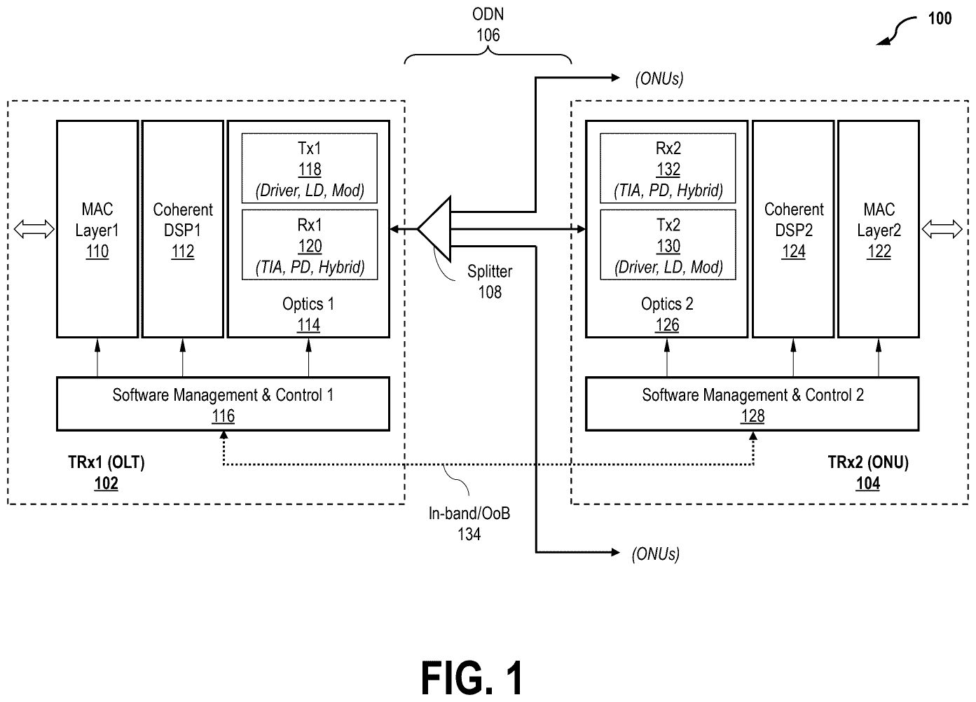

FIG. 1 is a schematic illustration depicting an exemplary reconfigurable coherent passive optical network system.

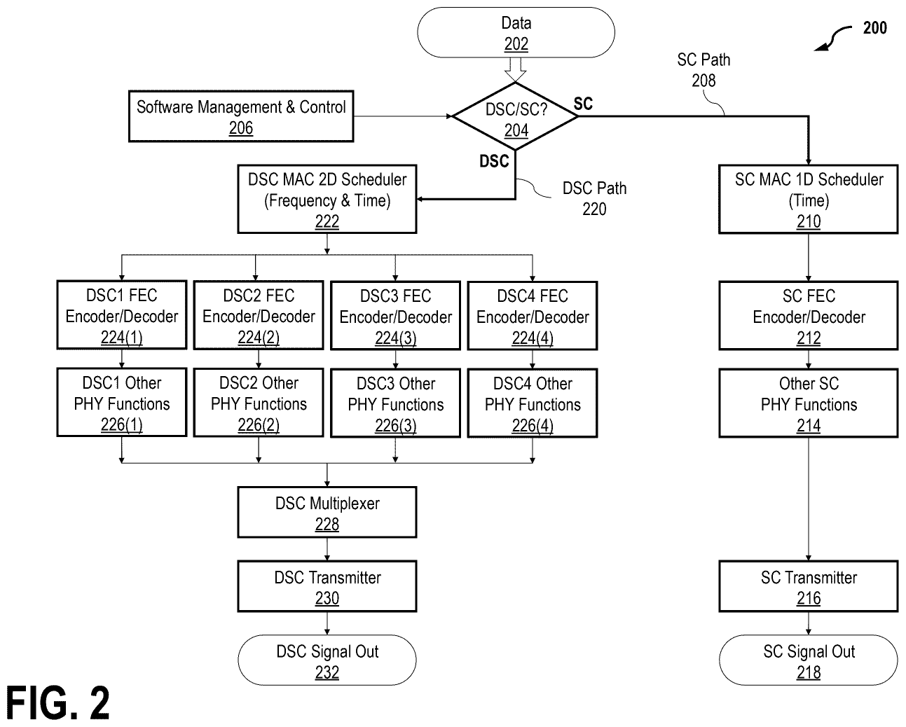

FIG. 2 is a schematic illustration depicting an exemplary logical scheduling architecture for coherent transmission.

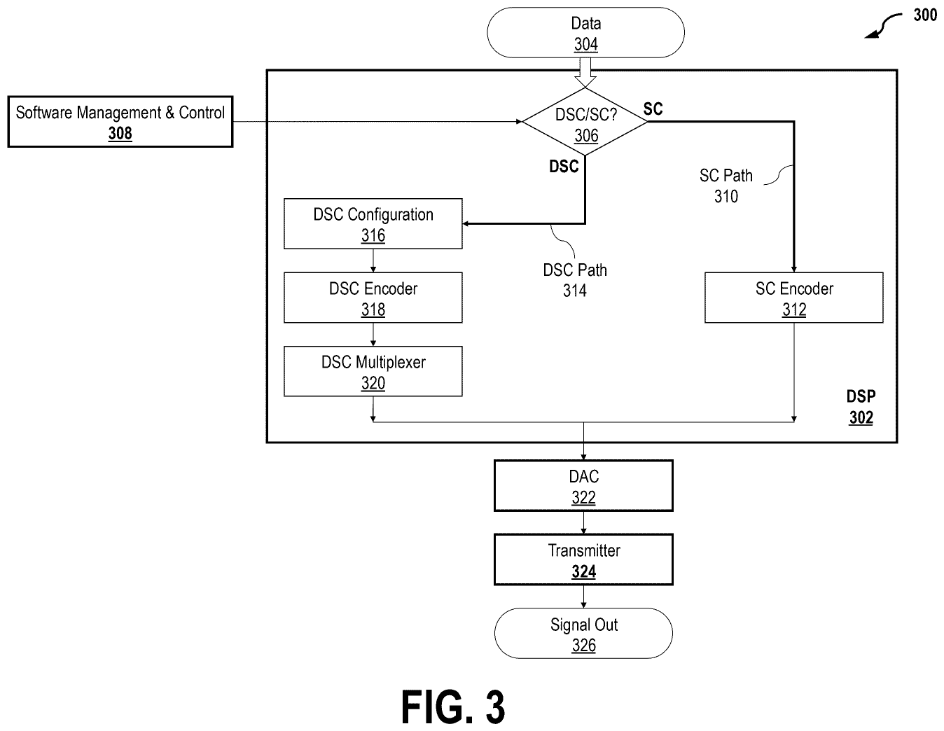

FIG. 3 is a schematic illustration depicting an exemplary logical processing architecture for coherent transmission.

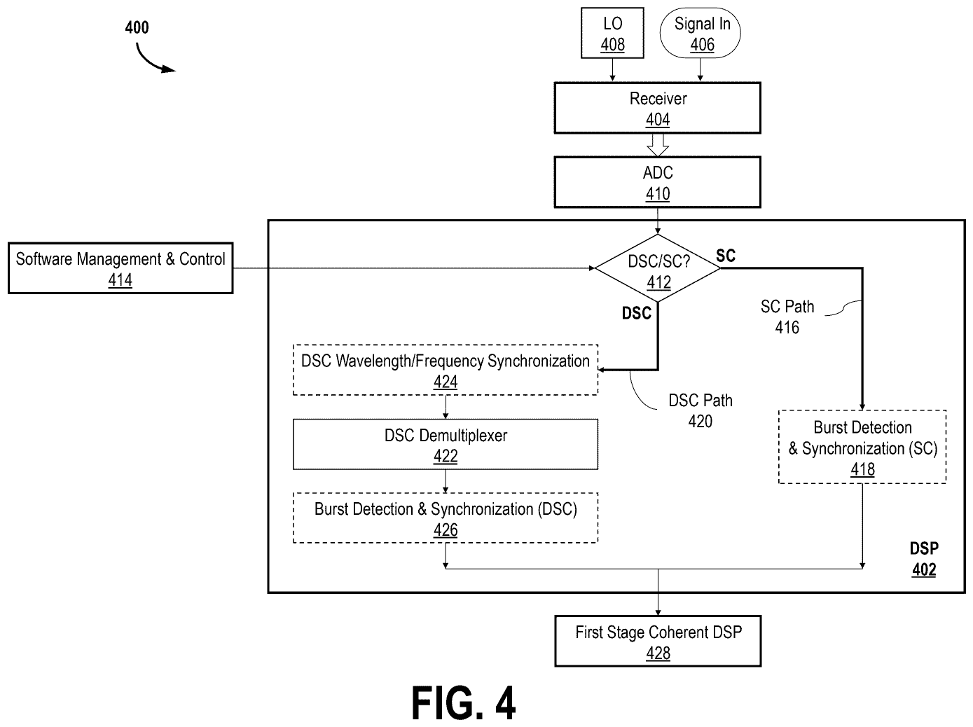

FIG. 4 is a schematic illustration depicting an exemplary logical processing architecture for coherent reception.

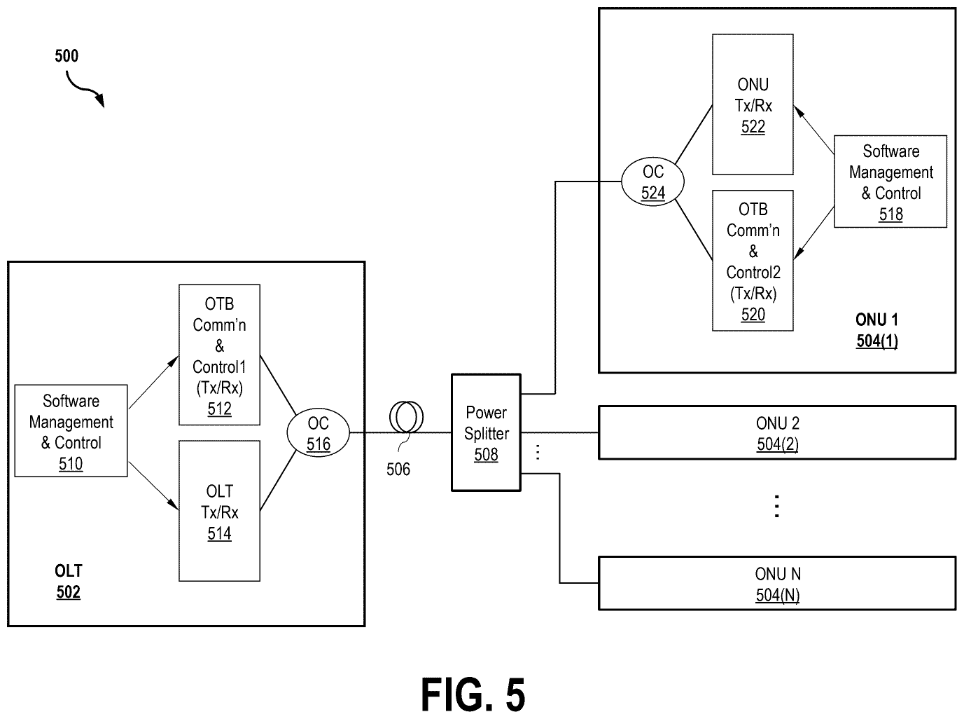

FIG. 5 is a schematic illustration of an exemplary system using out-of-band communication.

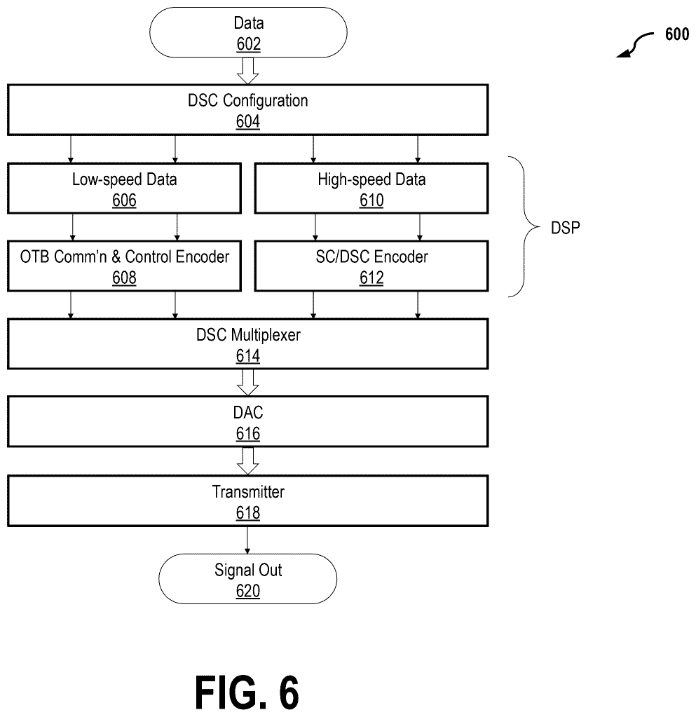

FIG. 6 is a schematic illustration depicting an exemplary logical transmission processing architecture for the system depicted in FIG. 5.

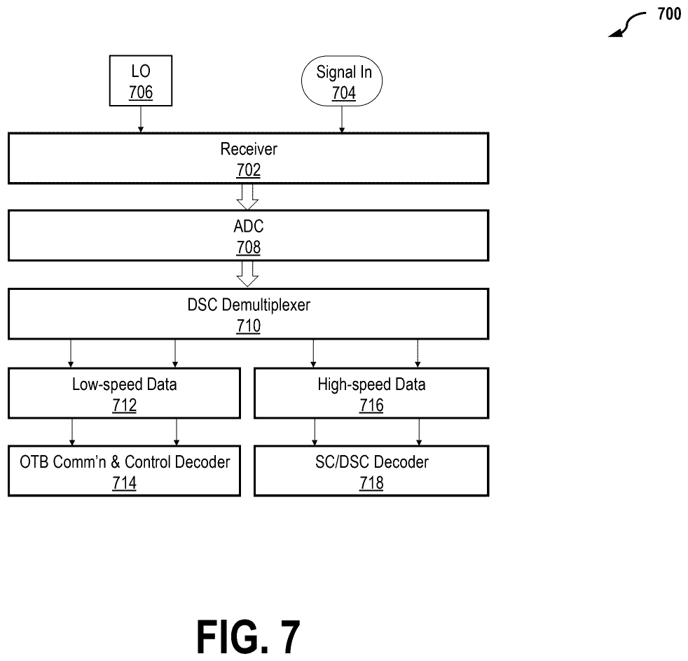

FIG. 7 is a schematic illustration depicting an exemplary logical reception processing architecture for the system depicted in FIG. 5.

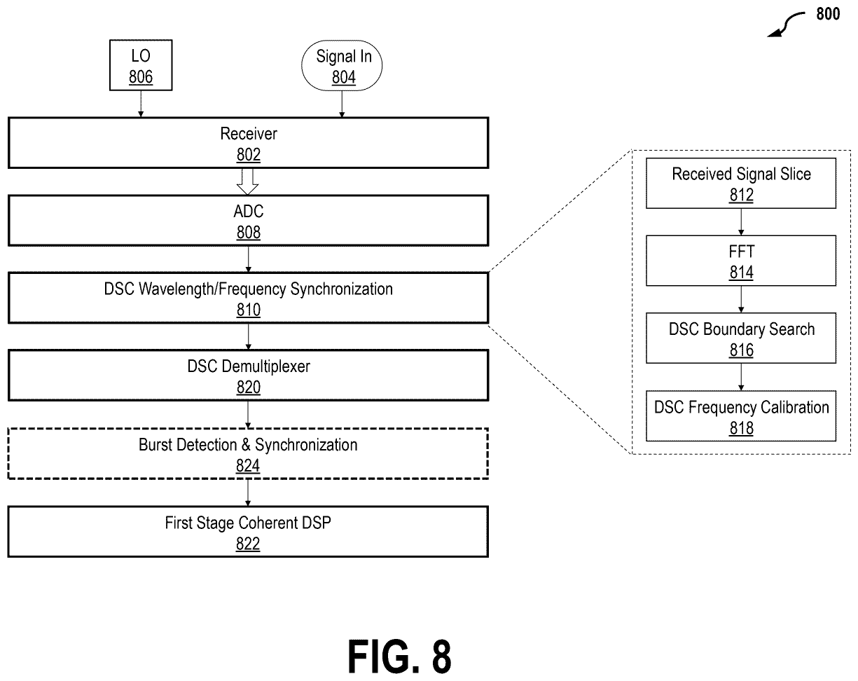

FIG. 8 is a schematic illustration depicting an alternative logical reception processing architecture for the system depicted in FIG. 5.

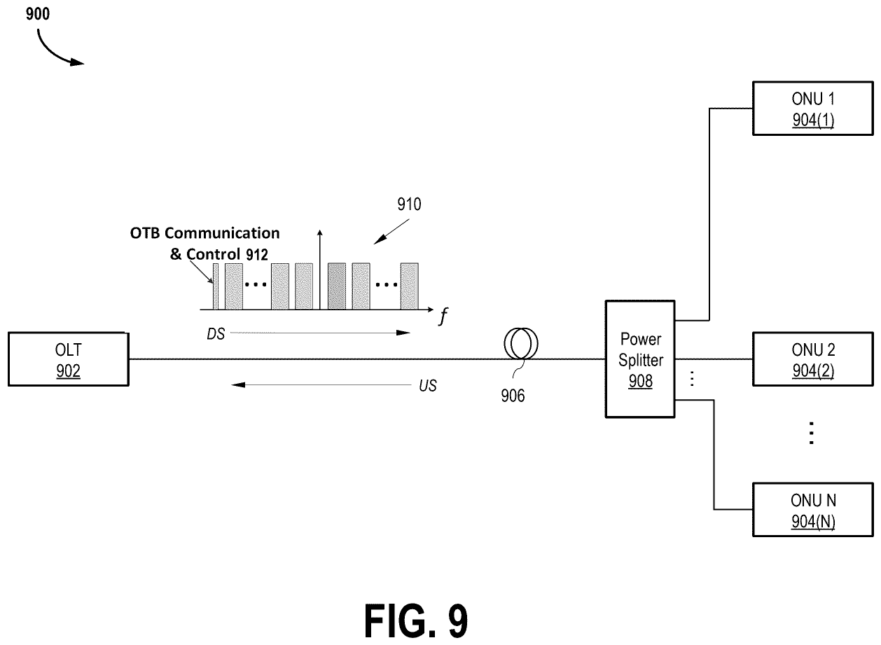

FIG. 9 is a schematic illustration of an alternative system using out-of-band communication.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events occur substantially instantaneously.

As used herein, “modem termination system” (MTS) refers to a termination unit including one or more of an Optical Network Terminal (ONT), an optical line termination (OLT), a network termination unit, a satellite termination unit, a cable modem termination system (CMTS), and/or other termination systems which may be individually or collectively referred to as an MTS.

As used herein, “modem” refers to a modem device, including one or more a cable modem (CM), a satellite modem, an optical network unit (ONU), a DSL unit, etc., which may be individually or collectively referred to as modems.

As used herein, the term “coherent transceiver,” unless specified otherwise, refers to a point-to-point (P2P) or a point-to-multipoint (P2MP) coherent optics transceiver having a coherent optics transmitting portion and a coherent optics receiving portion. In some instances, the transceiver may refer to a specific device under test (DUT) for several of the embodiments described herein.

As described herein, a “PON” generally refers to a passive optical network or system having components labeled according to known naming conventions of similar elements that are used in conventional PON systems. For example, an OLT may be implemented at an aggregation point, such as a headend/hub, and multiple ONUs may be disposed and operable at a plurality of end user, customer premises, or subscriber locations. Accordingly, an “uplink transmission” refers to an upstream transmission from an end user to a headend/hub, and a “downlink transmission” refers to a downstream transmission from a headend/hub to the end user, which may be presumed to be generally broadcasting continuously (unless in a power saving mode, or the like).

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, e.g., for communications, data storage, etc. A data center may include numerous redundant or backup components within the infrastructure thereof to provide power, communication, control, and/or security to the multiple components and/or subsystems contained therein. A physical data center may be located within a single housing facility, or may be distributed among a plurality of co-located or interconnected facilities. A ‘virtual data center’ is a non-tangible abstraction of a physical data center in a software-defined environment, such as software-defined networking (SDN) or software-defined storage (SDS), typically operated using at least one physical server utilizing a hypervisor. A data center may include as many as thousands of physical servers connected by a high-speed network.

As used herein, the term “hyperscale” refers to a computing environment or infrastructure including multiple computing nodes, and having the capability to scale appropriately as increased demand is added to the system, i.e., seamlessly provision infrastructure components and/or add computational, networking, and storage resources to a given node or set of nodes. A hyperscale system, or “hyperscaler” may include hundreds of data centers or more, and may include distributed storage systems. A hyperscale system may utilize redundancy-based protection and/or erasure coding, and may be typically configured to increase background load proportional to an increase in cluster size. A hyperscale node may be a physical node or a virtual node, and multiple virtual nodes may be located on the same physical host. Hyperscale management may be hierarchical, and a “distance” between nodes may be physical or perceptual. A hyperscale datacenter may include several performance optimized datacenters (PODs), and each POD may include multiple racks and hundreds and thousands of compute and/or storage devices.

As described herein, the terms “downstream” and “upstream” are relative, and are used for illustrative purposes, and not in a limiting sense. The person of ordinary skill in the art will understand that such relative terminology is meant to convey points of reference to distinguish one direction of transmission with respect to another direction over a PON.

In an exemplary embodiment, systems and methods are provided to easily reconfigure a CPON between one-dimensional SC signals and multi-dimensional DSC signals. The present coherent detection-based solutions thus represent significant improvements over conventional direct-detection-based solutions, which are confined to the one-dimensional use of amplitude to represent the signal. In an embodiment, for coherent reception, use of a local oscillator (LO) provides significant coherent gain, as well as wavelength selectivity, without the need of an optical filter. According to the present embodiments, the CD-induced power fading seen by conventional systems using direct-detection is no longer an issue because of optical field recovery of the coherent detection technology.

In an embodiment, a CPON according to the present systems and methods achieves superior receiver sensitivity, which in turn enables an extended power budget. In some embodiments, the present CPON further enables DWDM systems and methods capable of realizing higher-capacity channels and fewer optical ports, thereby providing improved operational simplicity that will significantly decrease operational and capital expenditure (OPEX and CAPEX, respectively) costs for the overall network.

In an exemplary embodiment, the present systems and methods are further advantageously configured to recover multi-dimensional signals using coherent detection provides, and thereby compensating for linear transmission impairments such as CD and polarization mode dispersion (PMD). According to the present systems and methods, significant improvements are achieved with respect to efficient use of fiber spectral resources, thereby freeing more of the optical spectrum for future use, while also enabling capabilities to more easily upgrade the network using multi-level advanced modulation formats.

Exemplary architectures of CPON architectures, as well as the respective components thereof, are also described in greater detail in U.S. Pat. Nos. 9,912,409, 10,200,123, and 10,523,356. Exemplary systems and methods for coherent burst reception are described in greater detail in co-pending U.S. patent application Ser. No. 17/401,473, filed Aug. 13, 2021, and U.S. patent application Ser. No. 17/346,940, filed Jun. 14, 2021. An exemplary rate-flexible CPON is described in co-pending U.S. patent application Ser. No. 18/905,880, filed Oct. 3, 2024. The disclosures of all of these prior patents and patent applications are incorporated by reference herein in their entireties.

Known CPON solutions include time division multiplexing (TDM) and time and frequency division multiplexing (TFDM) for coherent TDM-PONs and coherent TFDM-PONs, respectively. A coherent TDM-PON may, for example, utilize power splitter-based ODNs, where an OLT transmits downstream signals continuously to each ONU on a single wavelength channel. For the corresponding upstream transmission, each ONU is assigned a specific timeslot to send upstream data on another wavelength channel. This coherent TDM-PON architecture only requires a single-carrier (SC) in each direction, rendering its overall infrastructure less complex in terms of optical hardware and media access control (MAC) layer control.

In contrast, a coherent TFDM-PON may, for example, combine TDM and frequency division multiplexing (FDM). A coherent TFDM-PON may accordingly transmit multiple DSCs over the same fiber by allocating different frequency bands to each subcarrier. In an embodiment, each frequency band of a coherent TFDM-PON may carry its own independent data stream, and accordingly utilize different time slots within each frequency band for different users or services. According to the present systems and methods, a TFDM CPON may realize significantly improved flexibility to share bandwidth in both of the time and frequency domains, thereby reducing scheduling latency and traffic blocking rates, and optimizing bandwidth utilization. Conventional TFDM-PON solutions, however, are known to require additional cost and complexity in terms of optical hardware and MAC layer control/scheduling. According to the present embodiments though, coherent TFDM CPON Simultaneously leverages the advantages from both TDM CPON and TFDM CPON technology to achieve a software-defined CPON supporting both SC and DSC operational modes.

As described herein, an “SC-based TDM PON” refers to a common PON type that uses a single wavelength to transmit data to and from multiple ONUs. The data of the SC-based TDM PON is divided into time slots, and each ONU may then be assigned a specific time slot to transmit and receive data. In contrast, a “DSC-based TFDM PON” refers to a new PON type that uses two or more frequency bands in the digital domain, over a single coherent transceiver, to transmit data to and from multiple ONUs. The data of the DSC-based TFDM PON is divided into time slots and frequency bands, and each ONU may then be assigned a specific time slot and frequency band to transmit and receive data.

Conventionally, the choice between DSC and SC implementation in the CPON has required a choice between the respective advantages and trade-offs of these two different operational modes. For example, DSC technology reduces the burst overhead in the upstream transmission for time-based sources of overhead, thereby facilitating additional link budget while maintaining overall capacity. For the network operator, DSC enables the introduction of additional subcarriers for individual customers/services, which will in turn and enhance the network flexibility. Nevertheless, conventional multi-carrier approaches, such as DSC, typically have to consider a trade-off in the peak-to-average power ratio (PAPR) loss.

In comparison, SC technology simplifies the capability of the network to achieve its target link budget by avoiding the PAPR loss typically seen using multi-carrier approaches. SC technology is additionally capable of exploiting excess bandwidth for power enhancement through shaping techniques, thereby contributing to improved system performance, while also eliminating compatibility concerns with existing MAC layers through seamless integration of SC modulation. Nevertheless, SC modulation technologies tend to lack of flexibility with respect to the physical division of customers, subscribers, or services, and also with respect to the reach extension to such various customers/subscribers/services. SC modulation approaches also typically have to consider a trade-off in the introduced increased burst overhead stemming from time-based overhead sources.

According to the present systems and methods, an enhanced CPON techniques are provided that greatly mitigate the conventional trade-offs between SC and DSC modes. In an exemplary embodiment, innovative systems and methods simultaneously support both SC and DSC modes in a flexible manner, utilizing software-defined techniques that may be disposed within a single programmable optical transceiver. The present embodiments are therefore of particular advantageous utility when deployed in one or both of an OLT and the ONUs of a CPON. In an exemplary embodiment, using an enhanced software-defined management and control techniques, a same transceiver may be utilized for each different PON scenario, operational mode, and/or configurations, thereby greatly reducing both the CAPEX and OPEX to simultaneously leverage the 2 different operational modes.

In an exemplary embodiment, an enhanced CPON system leverages similar structures and functionalities between SC and DSC modes, such as the primary hardware used for optics, electronics, and functional building blocks for DSP. The present systems and methods thus realize even greater cost reductions from this innovative consolidation. That is, whereas conventional PON systems would require separate transceivers for each operational mode, the enhanced CPON techniques of the present embodiments integrate SC and DSC operational functionality into a single transceiver, thereby enabling network operators to flexibility utilize SC or DSC operational modes based on specific link conditions and performance requirements, but without requiring additional hardware or system modifications to support the multiple modalities.

FIG. 1 is a schematic illustration depicting an exemplary reconfigurable CPON 100. In the exemplary embodiment depicted in FIG. 1, reconfigurable CPON 100 includes a central first transceiver 102 in operable communication with a plurality (i.e., 1−N) of second transceivers 104 over an ODN 106 (e.g., optical fiber infrastructure) branching from first transceiver 102 to respective second transceivers 104 using at least one splitter 108 in a P2MP topology. For ease of explanation, first transceiver 102 is depicted herein as an OLT and second transceivers 104 are depicted as ONUs; however, the person of ordinary skill in the art will understand that first transceiver 102 may include additional or different MTS types, and that second transceivers 104 may be representative of various end-user transceivers, including without limitation customer premises equipment (CPEs) and/or modems. OLT 102, for example, may be located within a central office, a communications hub, or a headend of an optical link (not separately shown in FIG. 1), and functions to convert standard signals from a service provider (also not shown) to various frequencies, modulation formats, and framing used by reconfigurable CPON 100.

In the exemplary embodiment, OLT 102 includes a first MAC layer 110, a first coherent DSP 112, a first optics infrastructure 114, and a first software management and control module 116. First optics infrastructure 114 may, for example, include a first transmitter 118 and a first receiver 120. First transmitter 118 may further include one or more conventional optical hardware components for transmission, including without limitation, a driver, a laser/laser diode (LD), and a modulator (not separately shown in FIG. 1). Similarly, first receiver 120 may further include one or more conventional optical hardware components for reception, including without limitation, a transimpedance amplifier (TIA), a photodetector (PD), a 90-degree optical hybrid, and an integrated coherent receiver (ICR) (also not separately shown in FIG. 1).

For ease of illustration, ONUs 104 are depicted herein to have a similar structure, and associated functionality, to OLT 102. Accordingly, in an exemplary embodiment, ONUs 104 may each include a second MAC layer 122, a second coherent DSP 124, a second optics infrastructure 126, a second software management and control module 128, a second transmitter 130, and a second receiver 132. As explained in greater detail below, OLT 102 and ONU 104 may be considered substantially similar, except perhaps in the case of burst mode transmission and/or reception. That is, in some embodiments, first transmitter 118 of OLT 102 may be configured to transmit in continuous mode, whereas first receiver 120 may be configured for burst mode reception. Similarly, second transmitter 130 of ONU 104 may be configured for burst mode transmission, whereas second receiver 132 may be configured to receive a continuous transmission from OLT 102.

In the exemplary embodiment depicted in FIG. 1, reconfigurable CPON 100 provides an innovative transceiver design for either or both of OLT 102 and ONU(s) 104 that enables a flexible configuration that supports both SC and DSC operational modes within the same transceiver. That is, the innovative incorporation of software management and control modules 116, 128 with optics infrastructure 114, 126, coherent DSPs 112, 124, and MAC layers 110, 122, respectively, enables the respective transceiver to operate in either or both of the SC and DSC modes. For example, OLT 102 may receive an SC upstream transmission from one ONU 104, but a DSC upstream transmission from a different ONU 104 (i.e., for a P2MP topology).

In an exemplary embodiment, first optics infrastructure 114 is configured to enable, in DSC mode, accurate synchronization between OLT 102 and ONUs 104 such that additional optical wavelengths or frequencies, gain control of each digital subcarrier, and more precise modulator bias control may be achieved to avoid spectral crosstalk and imaging overlap. In SC mode though, first optics infrastructure 114 may be configured to relax frequency control requirements. Irrespective of the operational mode, the hardware of the particular transmitter (e.g., transmitters 118, 130, receivers 120, 132) need not be altered; the present systems and methods enable reconfigurable dual-mode operation using the innovative software and firmware techniques described herein.

In an exemplary embodiment, first coherent DSP 112 is configured to enable, in DSC mode, multiple subcarriers to be multiplexed (e.g., for OLT 102) and/or demultiplexed (e.g., for second coherent DSP 124, ONU 104) in the digital domain. In some embodiments, first coherent DSP 112 may be further configured for gain control of each DSC subcarrier in parallel, error correction and/or FEC encoding/decoding, and burst processing (e.g., at the OLT end). In SC mode though, as explained further below, first coherent DSP 112 may bypass (e.g., render optional) a number of the DSP functions performed in the DSC operational mode when processing only a single-channel flow.

In an exemplary embodiment, first MAC layer 110 may be software-configured such that, in the DSC mode, a channel bonding protocol is begun and single-dimension scheduling (i.e., from SC mode) is switched to two-dimensional time and frequency scheduling. First MAC layer 110 may be additionally configured such that the relevant service adaptation layer is adjusted to meet different service requirements, including without limitation, quality of service (QOS), service provisioning, low-latency subcarrier channels, and high-security subcarrier channels. In SC mode, first MAC layer 110 may be configured for single-dimension scheduling, such as time-slot allocation, and may also switch from two-dimensional scheduling to one-dimensional scheduling, if needed. In an embodiment, when transitioning between DSC and SC modes, the gain may be adjusted to meet similar link budget requirements between the operational modes. For example, in consideration of the overall system budget, SC operation tends to realize and approximately 3-4 dB improvement in comparison with DSC operation using the same transceiver hardware elements for both operational modes.

In an exemplary embodiment, and in coordination with the other respective transceiver elements described above, first software management and control module 116 may be further configured to communicate with second software management and control module 128 over a communication channel 134. In some embodiments, communication channel 134 may be in-band. In other embodiments, communication channel 134 may be out-of-band (OoB, or OTB), such as in the case where network devices are managed and/or controlled over a separate communication channel from the channel(s) used for primary data transmission. In an exemplary embodiment, software management and control modules 116, 128 enable direct coordination between OLT 102, ONU 104, respectively, to enable synchronization and dynamic reconfiguration of the operational modes of the respective transceivers.

The person of ordinary skill in the art will appreciate that these depictions are provided by way of example, and are not intended to be limiting. Other and/or additional structural or functional transceiver configurations may be implemented without departing from the scope herein.

FIG. 2 is a schematic illustration depicting an exemplary logical scheduling architecture 200 for a coherent transmission. In the exemplary embodiment depicted in FIG. 2, logical scheduling architecture 200 may be implemented with respect to one or more CPON transceivers (e.g., OLT 102 and/or ONU 104 of CPON 100, FIG. 1), as described herein. In an embodiment, scheduling architecture 200 receives an input digital data signal 202 at an operational mode selection unit 204 that is in communication with a software management and control module 206 (e.g., first or second software management and control modules 116, 128, respectively, FIG. 1). In an exemplary embodiment, operational mode selection unit 204 may be disposed within a DSP (e.g., first or second coherent DSPs 112, 124, respectively, FIG. 1).

In exemplary operation, operational mode selection unit 204, in coordination with software management and control module 206, determines whether input digital data signal 202 is for a single-channel flow or a multi-channel flow. In the case where operational mode selection unit 204 determines that input digital data signal 202 is for a single-channel flow, input digital data signal 202 is digitally processed over an SC processing path 208. SC processing path 208 may include one or more of an SC MAC one-dimensional scheduler 210 (e.g., first or second MAC layer 110, 122, respectively, FIG. 1) for time-slot allocation, and SC FEC encoder/decoder 212, and an additional SC subprocessor 214 for executing one or more additional physical (PHY) layer functions that may be desired for single-channel processing of input digital data signal 202. From SC processing path 206, the processed digital signal is then sent to an SC transmitter 216 (e.g., first or second transmitters 118, 130, respectively, FIG. 1) for transmission as an output SC signal 218.

If, on the other hand, operational mode selection unit 204 determines that input digital data signal 202 is for a multi-channel flow, input digital data signal 202 is digitally processed over a DSC processing path 220. In an exemplary embodiment, DSC processing path 220 includes a DSC MAC two-dimensional scheduler 210 (e.g., MAC layer 110, 122, FIG. 1) for time and frequency allocation. In the exemplary embodiment depicted in FIG. 2, the DSC multi-channel flow is illustrated with respect to four distinct subchannels of allocated frequencies. The person of ordinary skill in the art will understand though, that more or fewer frequency subchannels may be implemented without departing from the scope herein.

In further exemplary operation of scheduling architecture 200, the allocated two-dimensional flows are individually processed by a DSC FEC encoder/decoder 224 and a DSC PHY subprocessor 226 for each allocated frequency subchannel, respectively. The separately processed digital DSC signals are then aggregated by a DSC multiplexer 228, and then sent to a DSC transmitter 230 for transmission as an output DSC signal 232. In the exemplary embodiment depicted in FIG. 2, SC transmitter 216 and DSC transmitter 230 are illustrated as separate transmitters; however, the person of ordinary skill in the art will understand that, according to the innovative systems and methods described herein, a single transmitter device may be utilized for both output SC signal 218 and output DSC signal 232.

According to the innovative configuration of logical scheduling architecture 200, the MAC scheduling functionality of architecture 200 supports both SC (e.g., MAC 1D scheduler 210) and DSC (e.g., MAC 2D scheduler 222) operational modes. Along DSC path 220 though, MAC 2D scheduler 222 may be further configured with additional capabilities, including without limitation, channel bonding, two-dimensional scheduling in both time and frequency, QoS, and service provisioning. In contrast, along SC and path 28, MAC 1D scheduler 210 may be configured to support one-dimensional scheduling in time. The person of ordinary skill in the art will understand though, that a single MAC layer (e.g., first MAC layer 110, or second MAC layer 122, FIG. 1) may be advantageously configured according to the present systems and methods, to functionally include both of MAC 1D scheduler 210 and MAC 2D scheduler 222. In an embodiment, the respective MAC layer may coordinate with software management and control module 206 to determine one- or two-dimensional resource allocation.

FIG. 3 is a schematic illustration depicting an exemplary logical processing architecture 300 for coherent transmission. In the exemplary embodiment depicted in FIG. 3, logical processing architecture 300 represents a simplified logic diagram for a coherent DSP 302 of a continuous transmission (e.g., first coherent DSP 112 of OLT 102, FIG. 1). The person of ordinary skill in the art will understand though, that this depiction is for illustrative purposes, and is not intended to be limiting. For example, as explained in greater detail in co-pending U.S. patent application Ser. No. 18/905,880, burst mode transmission is also available. Logical processing architecture 300 is therefore similar, in many aspects, to logical scheduling architecture 200, FIG. 2, except that whereas logical scheduling architecture 200 emphasizes the MAC scheduling support for both SC and DSC modes, namely, from the MAC layer (e.g., first MAC layer 110, FIG. 1), logical processing architecture 300 is more illustrative of how coherent DSP 302 additionally, or alternatively, also supports both SC and DSC modes.

In an embodiment, processing architecture 300 receives an input digital data signal 304 at an operational mode selection unit 306 that is in communication with a software management and control module 308 (e.g., first or second software management and control modules 116, 128, respectively, FIG. 1). In exemplary operation, operational mode selection unit 306, in coordination with software management and control module 308, determines whether input digital data signal 304 is for a single-channel flow or a multi-channel flow. For single-channel flows, input digital data signal 304 is digitally processed over an SC processing path 310, which may include an SC encoder 312. For multi-channel flows, on the other hand, input digital data signal 304 is processed over a DSC processing path 314, which may include one or more of a DSC configuration unit 316 followed by a DSC encoder 318, and then a DSC multiplexer 320 (e.g., in the event that the multi-channel signals are separated prior to exiting coherent DSP 302).

In further exemplary operation of logical processing architecture 300, the digital signals exiting coherent DSP 302 are converted by a digital-to-analog converter (DAC) 322, and the resultant analog signals are then fed to a transmitter 324 (e.g., first or second transmitters 118, 130, respectively, FIG. 1) for transmission as an output signal 326.

FIG. 4 is a schematic illustration depicting an exemplary logical processing architecture 400 for coherent reception. In the exemplary embodiment depicted in FIG. 4, logical processing architecture 400 also supports dual-mode SC/DSC operation using a single coherent DSP unit (e.g., first or second coherent DSPs 112, 124, respectively, FIG. 1) for the same receiver 404 (e.g., first or second receivers 120, 132, respectively, FIG. 1). In exemplary operation, receiver 404 detects an input analog optical signal 406 (e.g., received over an ODN, such as ODN 106, FIG. 1), as well as a light source from a local oscillator (LO) 408. The received signals are then converted by an analog-to-digital converter (ADC) 410 prior to processing by coherent DSP 402.

In exemplary operation of coherent DSP 402, the digitally converted signals from ADC 410 are received at an operational mode selection unit 412 that is in communication with a software management and control module 414 (e.g., first or second software management and control modules 116, 128, respectively, FIG. 1). In further exemplary operation, operational mode selection unit 412, in coordination with software management and control module 414, determines whether the received converted digital data signal is for a single-channel flow or a multi-channel flow. For single-channel flows, the converted digital signals are digitally processed over an SC processing path for 16, which may optionally include an SC burst detection and synchronization unit 418 (e.g., in the case where input signal 406 is a burst mode transmission, such as burst mode receiver 120 in OLT 102.

However, in the case where operational mode selection unit 412 determines converted analog multi-channel flows, coherent DSP 402 will process the analog multi-channel flows along DSC path 420. In an exemplary embodiment, DSC path 420 includes at least one DSC demultiplexer 422. The output of coherent DSP 402, irrespective of whether the output represents one or both of SC- and DSC-processed signals, is sent to a conventional first stage coherent DSP subprocessor 428. Exemplary first stage coherent DSP subprocessors are described in greater detail in co-pending U.S. patent application Ser. No. 18/905,880.

In at least one embodiment, coherent DSP 402 further includes an optional DSC wavelength and frequency synchronization unit 424 disposed prior to DSC demultiplexer 422 (i.e., in logical order). Alternatively, synchronization may be achieved, for example, through the utilization of an OTB channel (e.g., communication channel 134, FIG. 1). In the case where the converted digital signals originate from burst-mode transmissions, DSC processing path 420 may further include an optional DSC burst detection and synchronization module 426 disposed after DSC demultiplexer 422, and prior to output from coherent DSP 402. For example, for implementation within an OLT (e.g., OLT 102, FIG. 1) in communication with burst-transmitting ONUs (e.g., ONUs 104, FIG. 1), burst detection and synchronization module 426 may be optionally utilized to detect the upstream bursts.

According to the exemplary systems and methods described above with respect to FIG. 4, coherent DSP 402 is advantageously enabled to share the majority of optical hardware to process both SC and DSC channel signals.

FIG. 5 is a schematic illustration of an exemplary system 500 using OoB/OTB communication. In the exemplary embodiment depicted in FIG. 5, system 500 is similar, in many aspects, to CPON 100, and includes an OLT 502 in operable communication with a plurality (i.e., 1−N) of ONUs 504 over an ODN 506 utilizing one or more power splitters 508 in a P2MP topology. In an exemplary embodiment, OLT 502 further includes a first software management and control module 510, a first OTB communication and control module 512, and an OLT optics infrastructure 514 (e.g., OLT transmitter and receiver hardware).

In the exemplary embodiment, respective inputs of first OTB communication and control module 512 and OLT optics infrastructure 514 are each in operable communication with a first software management and control module 510, and respective outputs of first OTB communication and control module 512 and OLT optics infrastructure 514 are each in operable communication with a first optical coupler 516. First optical coupler 516 is configured to combine SC and DSC signals from OLT optics infrastructure 514 with OTB communication signals from first OTB communication and control module 512 4 aggregated transport over ODN 506. The person of ordinary skill in the art will understand that this simplified configuration for OLT 502 is provided by way of illustration, and is not intended to be limiting. More (i.e., MAC layer, DSP, etc.) or fewer components may be contained within OLT 502 without departing from the scope herein.

For ease of explanation, ONU 504 is depicted to have a similar structure and functionality as that described with respect to OLT 502. For example, each ONU 504 may include one or more of a second software management and control module 518, a second OTB communication and control module 520, and an ONU optics infrastructure 522 (e.g., ONU transmitter and receiver hardware). Accordingly, either or both of OLT 502 and ONU 504 may implement continuous and/or burst transmission and reception techniques without departing from the scope herein.

In the exemplary embodiment, first and second OTB communication and control modules 512, 520 utilized low-bandwidth optics for OTB communication and control. In some embodiments, it is advantageous to provide hardware for first and second OTB communication and control modules 512, 520 that is separate from OLT and ONU optics infrastructures 514, 522, respectively, to ensure that the OTB communication signals do not occupy the same transceiver bandwidth as the respective OLT and ONU SC/DSC carrier signals. The solution depicted in FIG. 5 is therefore of particular advantageous utility in the case where bandwidth restrictions are of greater concern to the network operator than the marginal cost increased to add respective optical hardware for first and second OTB communication and control modules 512, 520.

FIG. 6 is a schematic illustration depicting an exemplary transmission processing architecture 600 for system 500, FIG. 5. Transmission processing architecture 600 is similar, in a number of aspects, to logical processing architecture 300, FIG. 3, and represents a simplified logic diagram for a coherent transmission. In the exemplary embodiment, transmission processing architecture 600 receives an input digital data signal 602 at a DSC configuration unit 604 (e.g., similar to DSC configuration unit 316, FIG. 3). DSC configuration unit 604 is then configured to split received DSC data into respective low-speed and high-speed data portions for communication signals and data channel signals, respectively. That is, low-speed communication data portions are sent to a low-speed data subprocessor 606, followed by an OTB communication and control encoder 608, and the high-speed channel data portions are sent to a high-speed data subprocessor 610, followed by an SC/DSC encoder 612.

In an exemplary embodiment, DSC configuration unit 604 may be disposed within or controlled by one or both of a MAC layer (first MAC layer 110, FIG. 1) and a software management and control module (e.g., first software management and control module 116, FIG. 1). Additionally, low-speed data subprocessor 606, OTB communication and control encoder 608, high-speed data subprocessor 610, and SC/DSC encoder 612 may constitute a portion of a coherent DSP (e.g., first coherent DSP 112, FIG. 1). The person of ordinary skill in the art will understand that the logical elements depicted in FIG. 6 are provided by way of illustration, and are not intended to be limiting. More or fewer processing elements may be included, configured in a different logical order, and/or disposed within different CPON transceiver elements without departing from the scope herein.

In further exemplary operation of transmission processing architecture 600, the separately processed low-speed communication signals and high-speed channel signals are aggregated by a DSC multiplexer 614 (e.g., similar to DSC multiplexer 320, FIG. 3), then converted by a DAC 616 (e.g., similar to DAC 322, FIG. 3), and the resultant analog signals are then fed to a transmitter 618 (e.g., similar to transmitter 324, FIG. 3) for transmission as a combined communication/carrier output signal 620.

According to the innovative principles described above with respect to transmission processing architecture 600, a simplified DSP logical configuration may realize similar OTB communication and control results as that described above with respect to system 500, FIG. 5, but through use of software defined low-bandwidth DSC signals, as opposed to separate dedicated hardware for OTB communication and control. That is, according to transmission processing architecture 600, no additional hardware is required to accomplish OTB communication and control, since the relevant OTB communication channels (e.g., low-speed data) are generated directly from the respective OLT or ONU optics infrastructures.

This solution depicted in FIG. 6 is described with respect to DSC signals for ease of explanation, and not in a limiting sense. According to transmission processing architecture 600, SC operational mode may also be implemented in the data channel by combining SC channel data with the OTB communication channel data. The solution is of particular utility to the network operator that does not wish to incur additional hardware costs, but has an excess link budget to realize this SC solution (i.e., in comparison with a “true” SC solution).

FIG. 7 is a schematic illustration depicting an exemplary logical reception processing architecture 700 for system 500, FIG. 5. Reception processing architecture 700 is similar, in some aspects, to logical processing architecture 400, FIG. 4, and represents a simplified logic diagram for coherent reception. In the exemplary embodiment, reception processing architecture 700 detects, at a receiver 702, an input analog optical signal 704 and a light source from an LO 706. The received analog optical signals are then converted by an ADC 708, and the resultant digital signals are then separated into respective low-speed and high-speed data portions for communication signals and data channel signals, respectively, by a DSC demultiplexer 710.

From DSC demultiplexer 710, low-speed communication data portions are processed by a low-speed data subprocessor 712, followed by an OTB communication and control decoder 714. In a similar manner, high-speed channel data portions from DSC demultiplexer 710 are processed by a high-speed data subprocessor 716, followed by an SC/DSC decoder 718.

According to the innovative principles described above with respect to reception processing architecture 700, software-defined OTB communication and control results are similarly achieved for coherent reception, and without requiring additional separate dedicated hardware for OTB communication and control. Similar to transmission processing architecture 600, FIG. 6, the depicted DSC solutions of reception processing architecture 700 are provided by way of illustration, and are not intended to be limiting. The coherent reception principles equally apply to the SC operational mode, and in consideration of the link budget trade-off in comparison with “true” SC solutions.

FIG. 8 is a schematic illustration depicting an alternative logical reception processing architecture 800 for system 500, FIG. 5. In the exemplary embodiment depicted and FIG. 8, reception processing architecture 800 is similar to reception processing architecture 700, FIG. 7, but described with respect to additional considerations that may be desired for coherent reception of SC/DSC burst signals. For example, reception processing architecture 800 similarly includes a receiver 802 configured to detect an input analog optical signal 804 and a light source from an LO 806. In exemplary operation, the received analog optical signals are then converted by an ADC 808 into one or more digital signals.

In an exemplary embodiment, the converted digital signals are then processed by a DSC wavelength and frequency synchronization unit 810 (e.g., similar to optional DSC wavelength and frequency synchronization unit 424, FIG. 4). DSC wavelength and frequency synchronization unit 810 may include one or more of a slicing unit 812 for receiving respective signal slices of the converted digital signals, a transform unit 814 configured to perform a fast Fourier transform (FFT) on the received signal slices, a DSC boundary search unit 816, and a DSC frequency calibration unit 818 configured to coordinate with a remote transceiver transmitting the received burst signals.

Accordingly, DSC wavelength and frequency synchronization unit 810 is advantageously enabled to recognize the DSC boundary and calibrate the frequency window based on detected DSC boundary. In an exemplary embodiment, DSC wavelength in frequency synchronization unit 810 is disposed within a coherent receiver DSP. The processed digitally calibrated signals are then separated by a DSC multiplexer 820, and then processed by a first stage coherent DSP subprocessor 822. In the case where input analog optical signal 804 is a burst signal, logical reception processing architecture 800 may further include an optional burst detection and synchronization unit 824 logically disposed between DSC demultiplexer 820 and first stage coherent DSP 822. According to this innovative solution, DSC wavelength and frequency synchronization may be performed directly by the coherent receiver DSP without requiring an additional OTB communication channel, while only needing to dedicate a few additional processing resources in the coherent receiver DSP.

FIG. 9 is a schematic illustration of an alternative system 900 using OTB communication. In the exemplary embodiment depicted in a FIG. 9, system 900 is similar, in many aspects, to system 500, FIG. 5, and includes an OLT 902 in operable communication with a plurality (i.e., 1−N) of ONUs 904 over an ODN 906 utilizing one or more power splitters 908 in a P2MP topology configured to transport a plurality of frequency channels 910 between OLT 902 and ONUs 904. System 900 may, therefore, be representative of an OTB communication CPON implementing one or more software-defined processing techniques, similar to those described above with respect to FIGS. 6-7.

According to the innovative configuration of system 900, OTB communication may be coordinated between OLT 902 and ONUs 904 (e.g., between the respective software management and control modules thereof) using a dedicated OTB communication and control channel 912 disposed within or proximate the bandwidth of transported frequency channels 910, which thereby enables the respective transceiver laser frequencies to be adjusted accordingly. In this manner, wavelength and frequency synchronization may be advantageously achieved without requiring additional separate hardware for OTB communication, and without requiring extra DSP resources dedicated for wavelength and frequency synchronization of the DSC signals of channels 910. The solution depicted in FIG. 9 may therefore be of particular utility where the network operator may want to avoid additional hardware and operational costs, and may instead dedicate a relatively small frequency portion (e.g., OTB communication and control channel 912) of transported frequency channels 910 solely for OTB communication and control. For example, a significantly smaller bandwidth would be needed to transport control signals than would be expected for the transport of SC and DSC data signals.

According to the systems and methods described herein, innovative structural configurations and processing techniques are provided that demonstrates significant advantages over conventional CPON systems. For example, according to the present embodiments, a same transceiver may be flexibly utilized within a number of different PON and CPON with only modest enhancements to the software and processing thereof. That is, the present systems and methods may be readily deployed within existing PON hardware and infrastructure configurations without requiring any physical modifications thereto. By enabling a single transceiver to achieve dual-mode operation (i.e., SC and DSC modes) the present embodiments realize significant cost reductions by eliminating the need for different transceivers to perform different respective operational modes. Such single-transceiver solutions that support multiple modalities thus further simplify both the inventory and the logistics of the network operator, and therefore provide an innovative software-defined CPON transceiver of significant value to next-generation (NG) optical access networks configured for 4G, 5G, 5G-NR, and 6G operation.

Exemplary embodiments for reconfigurable CPONs are described above in detail. The systems and methods of this disclosure though, are not limited to only the specific embodiments described herein, but rather, the components and/or steps of their implementation may be utilized independently and separately from other components and/or steps described herein. Additionally, the exemplary embodiments can be implemented and utilized in connection with other access networks utilizing fiber and coaxial transmission at the end user stage.

As described above, the DOCSIS protocol may be substituted with, or further include protocols such as EPON, RFOG, GPON, Satellite Internet Protocol, without departing from the scope of the embodiments herein. The present embodiments are therefore particularly useful for communication systems implementing a DOCSIS protocol, and may be advantageously configured for use in existing 4G and 5G networks, and also for new radio (NR), 5G-NR, 6G, and future generation network implementations.

Although specific features of various embodiments of the disclosure may be shown in some drawings and not in others, such illustrative techniques are for convenience only. In accordance with the principles of the disclosure, a particular feature shown in a drawing may be referenced and/or claimed in combination with features of the other drawings.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processor (DSP) device, and/or any other circuit or processor capable of executing the functions described herein. The processes described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term “processor.”

This written description uses examples to disclose the embodiments, including the best mode, and also enables a person skilled in the art to practice the embodiments, including the make and use of any devices or systems and the performance of any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A first coherent transceiver for a coherent passive optical network (CPON), comprising:
a media access control (MAC) layer configured to enable dual-mode operation of the first coherent transceiver;
a software management and control module configured to communicate with a remote second transceiver over a first channel of an optical distribution network (ODN);
a coherent digital signal processor (DSP) in communication with the software management and control module, and configured to process a digital data signal from the MAC layer; and
a coherent optics infrastructure configured to transmit and receive analog data signals over the ODN to and from the remote second transceiver, respectively,
wherein the analog data signals include (a) a communication subcarrier, and (b) a data subcarrier,
wherein the digital data signal from the MAC layer includes (a) a first data portion including control information from the communication subcarrier, and (b) a second data portion including primary information from the data subcarrier, and
wherein the coherent DSP is further configured to dynamically reconfigure processing of the digital data signal between a first operational mode and a second operational mode based on a transport type of the data subcarrier.

2. The first coherent transceiver of claim 1, wherein the wherein the CPON is configured in a point-to-multipoint (P2MP) topology.

3. The first coherent transceiver of claim 2, further comprising an optical line terminal (OLT), and wherein the remote second transceiver includes plurality of optical network units (ONUs), and wherein the ODN includes at least one splitter configured to branch an optical fiber from the first transceiver to the plurality of ONUs.

4. The first transceiver of claim 1, wherein the communication subcarrier is configured for in-band transport with the data subcarrier over the first channel.

5. The first transceiver of claim 1, wherein the communication subcarrier is configured for out-of-band (OoB) transport with the data subcarrier, wherein the communication subcarrier is configured for transport over the first channel, and wherein the data subcarrier is configured for transport over a second channel different from the first channel.

6. The first transceiver of claim 1, wherein the transport type of the data subcarrier is at least one of single-channel (SC) transport and multiple digital subcarrier (DSC) transport.

7. The first transceiver of claim 6, wherein the transport type of the data subcarrier is SC transport, and wherein the MAC layer is further configured for one-dimensional scheduling of the digital data portion.

8. The first transceiver of claim 7, wherein the one-dimensional scheduling includes time-slot allocation.

9. The first transceiver of claim 7, wherein the MAC layer is further configured to switch from a DSC operational mode to an SC operational mode.

10. The first transceiver of claim 6, wherein the transport type of the data subcarrier is DSC transport, and wherein the MAC layer is further configured for two-dimensional scheduling of the digital data portion.

11. The first transceiver of claim 10, wherein the two-dimensional scheduling includes DSC allocation in the time domain and in the frequency domain.

12. The first transceiver of claim 10, wherein the coherent DSP is further configured for wavelength and frequency synchronization of the multiple DSC.

13. The first transceiver of claim 10, wherein the coherent DSP is further configured to multiplex the multiple DSC in the digital domain.

14. The first transceiver of claim 10, wherein the MAC layer is further configured to (a) execute a channel bonding protocol for the multiple DSC, and (b) switch from an SC operational mode to a DSC operational mode.

15. The first transceiver of claim 1, wherein the coherent optics infrastructure includes a coherent transmitter and a coherent receiver.

16. The first transceiver of claim 15, wherein the coherent receiver is configured for burst detection.

17. A digital signal processor (DSP) for a coherent transceiver, comprising:
a processor input configured to receive an input digital data signal;
an operational mode selection unit configured to select between a single-channel (SC) operational mode of the coherent transceiver and a multiple-channel (DSC) operational mode of the coherent transceiver;
an SC processing path for processing the input digital data signal in the SC operational mode;
a DSC processing path for processing the input digital data signal in the DSC operational mode; and
a processor output configured to output results from the SC and the DSC processing paths.

18. The DSP of claim 17, wherein the input digital data signal includes (a) a first data portion containing communication information enabling the operational mode selection unit to select between the SC and DSC operational modes, and (b) a second data portion containing data subcarrier information for transport over an optical distribution network (ODN) of a coherent passive optical network (CPON).

19. The DSP of claim 18, further comprising a low-speed subprocessor for processing the first data portion, and a high-speed subprocessor for processing the second data portion.

20. The DSP of claim 17, wherein the DSC processing path includes (a) a configuration unit for dividing input digital data signal into a plurality of divided frequency data subcarriers, (b) a plurality of channel encoders configured to individually receive and encode each data subcarrier of the plurality of divided frequency data subcarriers, and (c) a multiplexer for combining the encoded data subcarriers into an aggregated digital signal.
